(19) United States
(12) Patent Application Publication
(10) Pub. No.: US 2025/0269383 A1
(43) Pub. Date: Aug. 28, 2025

(54) Material processing plant and drive for a mobile material processing plant

(71) Applicant: Kleemann GmbH, Göppingen (DE)

(72) Inventor: Michael Gnam, Blaubeuren (DE)

(21) Appl. No.: 19/038,324

(22) Filed: Jan. 27, 2025

(30) Foreign Application Priority Data
Feb. 22, 2024 (DE) 10 2024 105 020.9

(51) Int. Cl. B02C 21/02; B02C 4/42

(52) U.S. Cl. CPC B02C 21/026; B02C 4/42

(57) ABSTRACT

A drive for a mobile material processing plant, in particular for a rock crusher, includes an internal combustion engine that drives a mechanical drive train on its drive end, wherein the drive train has an output end having at least one output, wherein the output(s) are used to drive at least one crusher unit and preferably one generator for generating electrical energy, in particular for use in the material processing plant and/or at least one hydraulic system having a hydraulic pump. For the benefit of optimized operation of the material processing plant, according to the disclosure provision is made for the internal combustion engine to be coupled to the drive train via a shiftable transmission having a variable transmission ratio.

### RELATED APPLICATIONS

The present application claims priority to German Patent Application Ser. No. DE 10 2024 105 020.9 filed Feb. 22, 2024, which is incorporated herein by reference.

### BACKGROUND OF THE DISCLOSURE

### Field of the Disclosure

The disclosure relates to a drive for a mobile material processing plant, in particular for a rock crusher, having an internal combustion engine that drives a drive train at its drive train's drive end, wherein the drive train has a drive train output end having at least one output, wherein the output(s) are used to drive at least one generator for generating electrical energy, in particular for use in the material processing plant, at least one hydraulic system having a hydraulic pump and one crusher unit.

### Description of the Prior Art

Such material processing plants according to the disclosure, for instance mobile crushing machines, can be equipped with a direct drive. The direct drive combines maximum efficiency with a very compact and robust design. These properties are decisive for material processing plants, in particular in contract crushing operations, and therefore also place special demands on the drive of the crusher unit.

In a direct drive, an internal combustion engine drives a mechanical drive train, to which a shifting clutch is assigned. This shifting clutch can function based on any of the common clutch principles. Friction or form-fitting principle, in accordance with the Fottinger principle or any other hydraulic power transmission or combinations of the above-mentioned principles. This shifting clutch is used to switch the crusher unit on or off. The shifting clutch drives a belt drive, for instance, to implement a suitable crusher speed via the belt drive transmission. Preferably, at least one hydraulic pump is also driven by the mechanical drive train, which in turn drives one or more auxiliary loads, such as fans, hydraulic drives or hydraulic cylinders. These hydraulic pumps can also drive larger loads, for instance, such as drives for conveyor belts, chutes, etc. In very efficient direct drives, the mechanical drive train also drives at least one power generator (as a replacement for or in addition to the hydraulic pumps), which supplies electrical energy to powerful auxiliary loads such as conveyor belts, chutes, screens and pump drives. The use of electric drives for these auxiliary loads instead of hydraulic drives significantly increases machine efficiency.

In production operation, in an application defined by the user, crushing machines usually operate at a constant drive speed of the internal combustion engine and a crusher speed. The crusher speed is preferably based on one or more of the application requirements listed below:
size of the material to be crushed, for instance rock material,
material properties of the material to be crushed, for instance rock material,
desired end material properties
etc.

Depending on the type of crusher unit, the crusher speed can therefore also be set to meet the requirements of the application. The crusher also requires a certain drive power depending on the application. The required drive power can vary significantly depending on the application, even at the same crusher speed.

In crushing machines having a direct drive known from the state of the art, a fixed transmission ratio is provided between the internal combustion engine and the crusher, which is usually specified by the ratio of the drive train and the belt drive. The speed of the crusher is thus implemented as required by adjusting the speed of the internal combustion engine. To this end, the design is such that the internal combustion engine can provide as much power as possible in the required speed range to offer sufficient performance even in applications having high power requirements.

It is usually also impossible to alter the ratios of the drive train to the hydraulic pumps and the generator, they are selected such that these components are within their TARGET operating range in terms of their performance applications. For instance, the generator has to supply a certain mains frequency, which has to be matched to the drives being operated. The mains frequency output is linked to the rotational frequency of the generator and thus to the ratio of the drive train between the internal combustion engine and generator. Contractor machines (“contract crushing”) in particular operate in very diverse applications, some of which have very varying performance requirements even at identical internal combustion engine speeds. Such machines often work for long periods in applications that only demand a fraction of the maximum possible performance.

Normally, engine characteristic maps of internal combustion engines offer comparatively poor efficiency in the lower load range, and high speeds also result in poorer efficiency.

The material crusher plants known from the state of the art cannot counteract this because the working speed of the internal combustion engine is designed for the highest possible output and is also linked to the TARGET speed of the crusher. In many applications, this results in unnecessarily high fuel consumption and CO2 emissions.

U.S. Pat. No. 10,335,800 B2 describes a material crusher plant, in particular a rock crusher having an internal combustion engine. The latter drives a hydraulic system. The hydraulic system supplies various hydraulic motors. One of these hydraulic motors drives a crusher unit. If the load conditions of the crusher unit change, a control device regulates the speed of the internal combustion engine, wherein the speed of the crusher unit is maintained, however. For this purpose, the flow rate through the hydraulic motor of the crusher unit is adjusted accordingly.

EP 3 251 748 B1 (U.S. Pat. No. 11,097,281) discloses a material crusher plant, in which an internal combustion engine is used as the drive unit. The internal combustion engine uses a drive train to drive a crusher unit. Furthermore, the internal combustion engine also drives a generator, which produces electrical energy while the internal combustion engine is running. The latter is stored in an accumulator. An auxiliary motor is assigned to the drive train, which auxiliary motor is driven by an electric motor and also contributes mechanical power to the drive train. If additional mechanical energy has to be made available in the drive train due to power peaks that the internal combustion engine cannot cover, the auxiliary engine can cover these power peak. In this way, the power in the drive train can be homogenized. This system is complex and susceptible to faults.

### SUMMARY OF THE DISCLOSURE

The disclosure addresses the problem of optimizing the operation of the internal combustion engine in a material processing plant of the type mentioned at the beginning, even for varying power requirements, wherein at the same time the reliable operation of the crusher unit is ensured.

This problem is solved by coupling the internal combustion engine to the drive train via a shiftable transmission having a variable transmission ratio.

The gearbox between the internal combustion engine and the drive train can be used to significantly extend the possible operating range and thus the engine characteristic map range of the internal combustion engine, wherein the output speed of the drive train for the crusher is maintained or essentially maintained.

In this way, the shiftable transmission can be brought to the appropriate gear shift stage for the specific application, wherein the speed of the internal combustion engine is brought to a suitable operating point. This saves fuel and CO2 emissions. At the same time, due to the set gear shift stage, the crusher unit runs at a constant speed or approximately at a constant speed with a certain bandwidth of a speed range, such that an optimum crushing result is also maintained.

In other words, provision may be made for operating the internal combustion engine at a lower speed range having the same absolute power requirement, but at the same time at a higher utilization. The engine characteristic map offers significantly better efficiency there.

According to a preferred variant of the disclosure, provision may be made for the shiftable transmission to have at least two fixed predetermined gear stages. This is a particularly simple and robust mechanical solution.

Alternatively, provision may also be made for the shiftable transmission to be a continuously variable transmission. This means that the operating point of the internal combustion engine can be adapted almost ideally depending on the power requirement of the crusher unit.

If the material processing plant according to the disclosure is a mineral processing device, for instance a rock crusher, provision may advantageously be made for the transmission ratio (i=drive speed/output speed) of the shiftable transmission to be variable in the range from i=0.5:1 to i=1.5:1. In this way, the requirements placed on such a machine for different applications can essentially be covered.

If provision is made for the transmission ratio of the shiftable transmission to be selected such that the output speed at the transmission output of the shiftable transmission or at the input of the drive train remains unchanged with a deviation of +−10%, preferably +−5%, when the input speed at the transmission input changes, it is ensured that the drive train is operated at essentially the same speed even when the input speed of the internal combustion engine varies. This ensures that the crusher unit and/or the other units connected to the drive train via assigned outputs can also be operated at essentially the same speed. In particular, no additional speed adjustments may need to be made to optimally drive the crusher unit or the additional units, which significantly simplifies the technical effort.

If provision is made for the internal combustion engine to be coupled to the shiftable transmission via a clutch, the shiftable transmission can be shifted to the appropriate gear stage during crushing operation. It is also conceivable to use a powershift transmission that can be shifted without a clutch, for instance a quick-shifter speed adjustment.

A possible variant of the disclosure can be such that the mechanical drive train has a main shaft and that the generator, the hydraulic pump and/or the crusher unit is/are coupled to the main shaft. The main shaft therefore represents a mechanically fixed assignment of the drive train of the internal combustion engine to these units.

In particular, provision may be made for the main shaft to be connected to a crusher clutch via a drive shaft, and for the crusher clutch to be connected directly or indirectly to the crusher unit at its output. In this way, the crusher unit can be decoupled from the drive train if required. Nevertheless, the drive train can continue to be operated by means of the internal combustion engine to continue using additional functions provided by the units coupled to the drive train.

According to a conceivable variant of the disclosure, provision may be made for the at least one hydraulic pump, the generator and/or a cooling fan for dissipating the heat loss of the internal combustion engine to be connected to the drive train, in particular to the main shaft, via an output assigned to each of these functional units at a fixed, non-variable transmission ratio. This supports a compact and robust design. Because the drive train runs at the same or approximately the same output speed in the different gear positions of the shiftable transmission, these units are then also operated at an optimum or approximately optimum operating point. This further improves the efficiency of the plant.

If provision is made for the drive train to have a further drive end via which a drive, in particular an electric motor, drives the drive train, then the drive train can be supplied with additional drive power. Provision may be made for the electric motor to support the internal combustion engine. However, preferably provision is made for the electric motor to replace the internal combustion engine in one operating state, for which purpose it can be decoupled from the drive train, for instance.

The problem of the disclosure is also solved by a mineral processing device having a drive according to the disclosure.

The disclosure is explained in greater detail below based on an exemplary embodiment shown in the drawings. In the Figures:

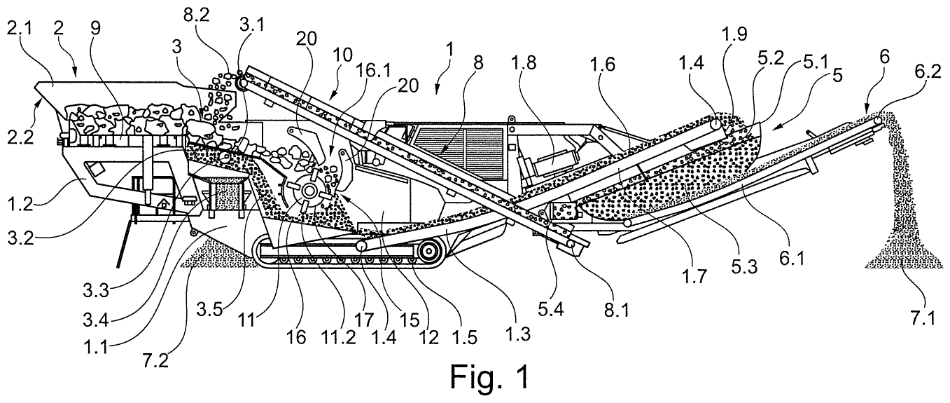

FIG. 1 shows a side view of a schematic representation of a material processing plant 1 having a crusher unit 10, and

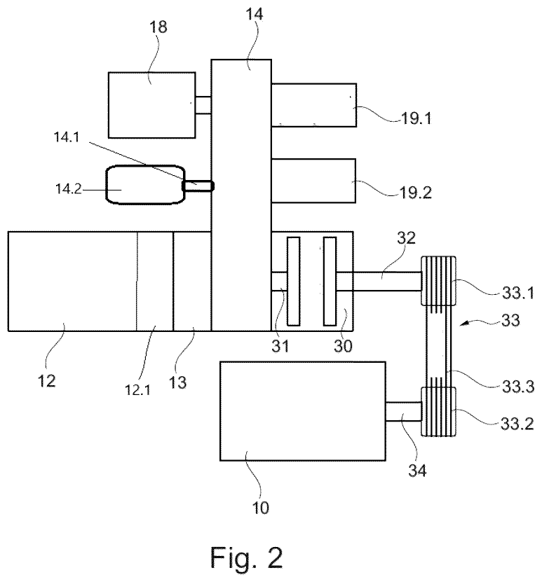

FIG. 2 is a schematic representation of a drive of the material processing plant shown in FIG. 1.

### DETAILED DESCRIPTION

FIG. 1 shows a material processing plant 1 in the form of a crusher having a material processing unit in the form of a crusher unit 10. The material processing plant 1 is designed as a mobile material processing plant 1 and therefore has travel units 1.5. However, it is also conceivable that the material processing plant 1 is a stationary material processing plant 1.

The material processing plant 1 has a chassis 1.1 that bears the machine components or at least a part of the machine components. At its rear end, the chassis 1.1 can preferably have a cantilever 1.2. A material feed area is formed in the area of the cantilever 1.2.

The material feed area may comprise a feed hopper 2 and a material feed device 9.

The feed hopper 2 may be formed at least in part by hopper walls 2.1 extending in the direction of the longitudinal extent of the material processing plant 1 and a rear wall 2.2 extending transversely to the longitudinal extent. The feed hopper 2 leads to the material feed device 9.

As shown in this exemplary embodiment, the material feed device 9 comprise have a conveyor chute that can be driven by means of a vibratory drive. The feed hopper 2 can be used to feed material to be comminuted into the material processing plant 1, for instance using a wheel loader, and to feed it onto the conveyor chute.

From the conveyor chute, the material to be comminuted passes into the area of a screen unit 3. This screen unit 3 may also be referred to as a pre-screening arrangement. At least one screen deck 3.1, 3.2 is disposed in the area of the screen unit 3. In this exemplary embodiment two screen decks 3.1, 3.2 are used.

A partial fraction of the material to be comminuted is screened out at the upper screen deck 3.1. This partial fraction already has a sufficient particle size that it no longer needs to be comminuted in the material processing plant 1. In this respect, this screened out partial fraction can be routed past the crusher unit 10 through a bypass channel 3.5.

If a second screen deck 3.2 is used in the screen unit 3, a further fine particle fraction can be screened out from the partial fraction that accumulates below the screen deck 3.1. This fine particle fraction can be routed to a lateral discharge conveyor 3.4 below the screen deck 3.2. The fine particle fraction is diverted from the lateral discharge conveyor 3.4 and conveyed to a rock pile 7.2 located laterally of the machine.

As FIG. 1 illustrates, the screen unit 3 may be a vibrating screen having a screen drive 3.3. The screen drive 3.3 causes the screen deck 3.1 and/or the screen deck 3.2 to vibrate. Owing to the inclined arrangement of the screen decks 3.1, 3.2 and in conjunction with the vibration motions, material on the screen decks 3.1, 3.2 is transported towards the crusher unit 10 or towards the bypass channel 3.5.

The material to be comminuted routed from the screen deck 3.1 is routed to the crusher unit 10, as shown in FIG. 1.

The crusher unit 10 may, for instance, take the form of a rotary impact crusher unit or a jaw crusher unit. If a rotary impact crusher unit is used, as in FIG. 1, it has an impact rotor 11, which is driven by an internal combustion engine 12. In FIG. 1, the axis of rotation 17 of the impact rotor 11 is horizontal in the direction of the image depth. The impact rotor 11 is housed in a crushing chamber 16.1.

If a jaw crusher unit is used, two crushing jaws, which enclose a converging crushing shaft between them, which leads to a crushing gap, are positioned facing each other.

For instance, the outer periphery of the impact rotor 11 may be equipped with impact bars 11.2. Opposite from the impact rotor 11, for instance, wall elements may be disposed, preferably in the form of impact rockers 20. When the impact rotor 11 is rotating, the impact bars 11.2 throw the material to be comminuted outwards. In so doing, this material hits the impact rockers 20 and is comminuted due to the high kinetic energy. When the material to be comminuted is of sufficient particle size to allow the material particles to pass through a crushing gap 15 between the impact rockers 20 and the radially outer ends of the impact bars 11.2, the comminuted material exits the crusher unit 10 through the crusher outlet 16.

It is conceivable that in the area of the crusher outlet 16, the comminuted material routed from the crusher unit 10 is combined with the material routed from the bypass channel 3.5 and transferred onto a belt conveyor 1.3. The belt conveyor 1.3 can be used to convey the material out of the working area of the crusher unit 10.

As shown in the drawings, the belt conveyor 1.3 may comprise an endless circulating conveyor belt having a slack side 1.6 and a tight side 1.7. The slack side 1.6 is used to catch and transport away the crushed material falling from the crusher outlet 16 of the crusher unit 10. At the belt ends, deflection rollers 1.4 can be used to deflect the conveyor belt from the slack side 1.6 to the tight side 1.7 and vice versa. Guides, in particular support rollers, can be provided in the area between the deflection rollers 1.4 to change the direction of conveyance of the conveyor belt, to shape the conveyor belt in a certain way and/or to support the conveyor belt.

The belt conveyor 1.3 has a belt drive, which can be used to drive the belt conveyor 1.3. The belt drive can preferably be disposed at the discharge end 1.9 or in the area of the discharge end 1.9 of the belt conveyor 1.3.

The belt conveyor 1.3 can be connected, for instance by means of the belt drive, to a control device by means of a control line.

One or more further belt conveyors 6 and/or a return conveyor 8 may be used, which in principle have the same design as the belt conveyor 1.3. In this respect, reference can be made to the above statements.

A magnet 1.8 can be disposed above the slack side 1.6 in the area between the feed end and the discharge end 1.9. The magnet 1.8 can be used to lift iron parts from the broken material and move them out of the conveying area of the belt conveyor 1.3.

A re-screening device 5 can be disposed downstream of the belt conveyor 1.3. The crusher unit 5 has a screen housing 5.1, in which at least one screen deck 5.2 is mounted. Below the screen deck 5.2, a housing base 5.3 is formed, which is used as a collection space for the material screened out at the screen deck 5.2.

An opening in the lower housing part 5.3 creates a spatial connection to the further belt conveyor 6. Here, the further belt conveyor 6 forms its feed area 6.1, wherein the screened material in the feed area 6.1 is directed onto the slack side of the further belt conveyor 6. The further belt conveyor 6 conveys the screened material towards its discharge end 6.2. From there, the screened material is transferred to a rock pile 7.1.

The material not screened out at the screen deck 5.2 of the re-screening device 5 is conveyed from the screen deck 5.2 onto a branch belt 5.4. The branch belt 5.4 can also be designed as a belt conveyor, i.e., reference can be made to the explanations given above with respect to the belt conveyor 1.3. In FIG. 1, the transport direction of the branch belt 5.4 extends in the direction of the image depth.

At its discharge end, the branch belt 5.4 transfers the un-screened material, also referred to as oversize material, to a feed area 8.1 of the return conveyor 8. The return conveyor 8, which may be a belt conveyor, conveys the oversize material towards the feed hopper 2. At its discharge end 8.2, the return conveyor 8 transfers the oversize material into the material flow, in particular into the material feed area. The oversize material can therefore be returned to the crusher unit 10 and crushed to the desired particle size.

FIG. 2 shows a drive of the material processing plant 1 according to FIG. 1. As this illustration shows, the drive comprises a mechanical drive train 14, which can be designed in particular as a gear unit, for instance as a gear transmission. Provision may be made for the drive train 14 to have a main shaft that directly or indirectly drives units of the material processing plant 1.

As this example shows, the drive train 14, for instance a main shaft of the drive train, at a drive train output end may drive a generator 18 to generate electrical energy for use in the material processing plant 1.

The electrical energy generated can be used, for instance, to supply a material processing unit 1 with electrical energy. By way of example, the electrical energy can be used to drive the travel units 1.5, at least one of the belt conveyors 1.3, the screen drive 3.3, the lateral discharge conveyor 3.4, the branch belt 5.4, the return conveyor 8 and/or the crusher unit 10.

It is also conceivable that the drive train 14 at one drive train output end drives at least one hydraulic pump 19.1, 19.2 of a hydraulic system. The hydraulic pump 19.1, 19.2 can be used to drive the travel units 1.5, at least one of the belt conveyors 1.3, the screen drive 3.3, the lateral discharge conveyor 3.4, the branch belt 5.4 and/or the return conveyor 8.

At one drive train drive end, the internal combustion engine 12 is coupled to the mechanical drive train 14 via a shiftable transmission 13. The shiftable transmission 13 may be indirectly coupled to the internal combustion engine 12, for instance via a non-shiftable clutch 12.1. Preferably, a flexible rubber coupling can be used, which is not shown in detail in FIG. 2. Accordingly, the clutch 12.1 can be used to couple/decouple the internal combustion engine 12 to/from the drive train 14. The clutch 12.1 can be used to decouple the internal combustion engine 12 to enable the shiftable transmission 13 to be shifted while the internal combustion engine 12 is in operation.

The shiftable transmission 13 can be designed as a mechanical manual transmission, in particular as a gear transmission. The shiftable transmission 13 can offer at least two transmission ratio variants. It can be designed as a PKF transmission (planetary bevel transmission), in particular also as a commercial vehicle transmission. It is also conceivable that the shiftable transmission 13 is a continuously variable transmission, for instance a transmission using pulleys having a variable diameter. The use of a CVT transmission (Continuously Variable Transmission) or an IVT transmission (Infinitely Variable Transmission) is conceivable.

The shiftable transmission 13 can be designed as a powershift transmission or as a non-powershift transmission 13.

If the shiftable transmission 13 is designed as a powershift transmission 13, a change in the reduction ratio provided by the shiftable transmission 13 can be achieved during operation of the internal combustion engine 12. This means that the shiftable transmission 13 can then be switched to a desired operating state during the operation of the internal combustion engine 12.

FIG. 2 further illustrates that the drive train 14 uses a drive shaft 31 to drive a switchable crusher clutch 30 on its drive train output end. On the output end, the crusher clutch 30 is connected via a transmission shaft 32 to a speed transmission 33 having a fixed transmission ratio. The speed transmission 33 may be formed by a belt drive. For this purpose, a drive wheel 33.1 may be connected to the output shaft 32, which drive wheel drives an output wheel 33.2 via a belt 33.2. The output wheel 33.2 is non-rotatably connected to a drive shaft 34, which drives the crusher 10.

During operation of the material processing plant 1, the internal combustion engine 12 uses the shiftable transmission 13 to drive the drive train 14. The generator 18 and/or at least one hydraulic pump 19.1, 19.2 are then also driven. In addition, the speed transmission 33 and thus the crusher 10 is also driven via the drive train 14 when the clutch 30 is closed.

The crusher 10 therefore runs at a specific speed that is suitable for the crushing task at hand.

Now it is possible that the internal combustion engine 12 is operated at a speed/power output ratio that is not consumption-optimized for this crushing task. This results in unnecessarily high fuel consumption and therefore unnecessary CO2 emissions.

To avoid this, the shiftable transmission 13 is now used to change the transmission ratio at which the internal combustion engine 12 is coupled to the drive train 14, for which purpose the shiftable transmission 13 assumes a different shift state.

The internal combustion engine 12 can then be operated at a speed/power output ratio that optimizes fuel consumption as much as possible. To this end, the speed of the internal combustion engine 12 is preferably adapted to the transmission ratio of the shiftable transmission 13 in such a way that the same output speed or approximately the same output speed is present on the output end(s) of the drive train 14, regardless of the selected shift stage. In other words, the same or approximately the same speed is applied to the drive shaft 31 when the shift state of the shiftable transmission 13 changes, to be able to operate the crusher 10 at as unchanged a speed as possible. The same applies to the drives of the hydraulic pump 19.1, 19.2 and/or of the generator 18.

This means that the crusher 10, at least one of the hydraulic pumps 19.1, 19.2 and/or the generator 18 can be operated at an approximately optimum operating point when the shift stage of the shiftable transmission 13 is changed.

According to a variant of the disclosure, the operation of the internal combustion engine 12 can be monitored with regard to its speed and power output by means of a monitoring device of a machine control system. The engine characteristic map of the internal combustion engine 12 can be stored in a memory unit of the machine control system. The machine control system determines the current engine characteristic map position of the internal combustion engine 12 continuously or at intervals.

The machine control system is then used to determine whether the internal combustion engine 12 is running at its optimum operating point. If this is not the case, determination is made whether the shiftable transmission 13 provides a shift stage that results in a significantly better operating point at which the output speed can be kept the same or approximately the same at least at the drive shaft 31. If there is such an optimized operating point, the shiftable transmission 13 is shifted to the optimized shift stage, either manually or automatically.

This means that the drive train 14 can always be operated at the optimum or near-optimum operating point in terms of fuel consumption and CO2 emissions.

Provision may be made for the drive train 14 to have a further drive end 14.1 via which a drive, in particular an electric motor 14.2, drives the drive train, then the drive train can be supplied with additional drive power. Provision may be made for the electric motor 14.2 to support the internal combustion engine 12. However, preferably provision is made for the electric motor 14.2 to replace the internal combustion engine 12 in one operating state, for which purpose it can be decoupled from the drive train 14, for instance.

1-14. (canceled)

15. A drive for a material processing plant, comprising:
an internal combustion engine;
a mechanical drive train including a drive end and an output end, the output end including at least one output, the at least one output being configured to drive at least one crusher unit of the material processing plant; and
a shiftable transmission coupling the internal combustion engine to the drive train, the shiftable transmission including a variable transmission ratio.

16. The drive of claim 15, wherein:
the at least one output is configured to drive an electrical energy generator for use in the material processing plant.

17. The drive of claim 15, wherein:
the at least one output is configured to drive at least one hydraulic system including a hydraulic pump.

18. The drive of claim 15, wherein:
the shiftable transmission includes at least two fixed ratio predetermined gear stages.

19. The drive of claim 15, wherein:
the shiftable transmission is a continuously variable transmission.

20. The drive of claim 15, wherein:
the shiftable transmission includes a transmission ratio of drive speed/output speed variable in a range from 0.5:1 to 1.5:1.

21. The drive of claim 15, wherein:
the shiftable transmission includes a transmission input and a transmission output, and the shiftable transmission is configured such that the transmission ratio of the shiftable transmission is selected such that an output speed at the transmission output of the shiftable transmission remains within a deviation of plus or minus 10% when a drive speed at the transmission input changes.

22. The drive of claim 15, wherein:
the shiftable transmission includes a transmission input and a transmission output, and the shiftable transmission is configured such that the transmission ratio of the shiftable transmission is selected such that an output speed at the transmission output of the shiftable transmission remains within a deviation of plus or minus 5% when a drive speed at the transmission input changes.

23. The drive of claim 15, wherein:
the internal combustion engine is coupled to the shiftable transmission by a clutch.

24. The drive of claim 15, wherein:
the mechanical drive train includes a main shaft; and
the crusher unit is coupled to the main shaft.

25. The drive of claim 24, further comprising:
a crusher clutch connected to the main shaft by a drive shaft, wherein the crusher clutch includes an output connected directly or indirectly to the crusher unit.

26. The drive of claim 15, wherein:
the at least one output is configured to drive an electrical energy generator for use in the material processing plant;
the mechanical drive train includes a main shaft; and
the electrical energy generator is coupled to the main shaft.

27. The drive of claim 15, wherein:
the at least one output is configured to drive at least one hydraulic system including a hydraulic pump;
the mechanical drive train includes a main shaft; and
the hydraulic pump is coupled to the main shaft.

28. The drive of claim 15, wherein:
the at least one output is configured to drive at least one functional unit at a fixed non-variable transmission ratio, the at least one functional unit being selected from the group consisting of a hydraulic pump, an electrical energy generator and a cooling fan for dissipating heat loss of the internal combustion engine.

29. The drive of claim 28, wherein:
the mechanical drive train is connected to the crusher unit by an endless circulating belt drive.

30. The drive of claim 15, wherein:
the mechanical drive train includes a further drive end by which an electric motor drives the mechanical drive train.

31. The drive of claim 15, wherein:
the at least one output includes an output which simultaneously drives a plurality of hydraulic pumps of a hydraulic system of the material processing plant.

32. The drive of claim 15, wherein:
the crusher unit is a jaw crusher, an impact crusher, a cone crusher or a roll crusher.

33. A mineral processing device including the drive of claim 15.
